(19) United States
(12) Patent Application Publication
(10) Pub. No.: US 2004/0003719 A1
(43) Pub. Date: Jan. 8, 2004

(54) Multi port air filter

(76) Inventors: Hung T. Le, St. Louis, MO (US); Hieu T. Le, St. Louis, MO (US); Tung T. Le, St. Louis, MO (US)

Correspondence Address: POLSTER, LIEDER, WOODRUFF & LUCCHESI, 763 SOUTH NEW BALLAS ROAD, ST. LOUIS, MO, 63141-8750, US

(21) Appl. No.: 10/608,837

(22) Filed: Jun. 27, 2003

Related U.S. Application Data
(60) Provisional application No. 60/393,482, filed on Jul. 3, 2002.

(51) Int. Cl. B01D 46/00

(52) U.S. Cl. 95/287; 55/485; 55/498; 55/502; 55/505; 55/521

(57) ABSTRACT

A multi port air filter for fuel injected engines provides for the installation of the air filter into the air intake line of an air intake system of a fuel injected engine. The multi port air filter has several filtering elements including an outside filter screen, a foam filter, and inside filter screen, a foam filter mesh, and a mesh filter. The foam filter is made from a flexible reticulated polyurethane foam material that allows proper air flow while maintaining good filtering capability.

### CROSS-REFERENCE TO RELATED APPLICATIONS

This application is related to U.S. Provisional Patent Application No. 60/393,482 filed Jul. 3, 2002 from which priority is claimed.

### STATEMENT REGARDING FEDERALLY SPONSORED RESEARCH OR DEVELOPMENT

Not applicable.

### BACKGROUND OF THE INVENTION

1. Field of the Invention

All gasoline engines are essentially pumps that draw air and fuel into the internal portion of the engine, and then discharge the remnants of the combustion process that occurs within the cylinders of the engine. While the fuel is usually drawn from a fuel tank dedicated to the engine, the air is normally ambient air drawn from the atmosphere surrounding the engine. This ambient air can be relatively clean or it can be filled with a number of various contaminants ranging from small particles like mold spore and plant pollen, to larger particles such as dust, leaves, and other road debris.

The presence of such contaminants within the ambient air drawn into the engine requires filtration of the air brought into the engine cylinders for internal combustion. A failure to filter the air properly will result in damage to the internal components of the engine.

However, the air filtration process introduces hot air and restrictions into the engine air intake system that robs the engine of usable horsepower. The horsepower output of any gasoline engine is very dependent upon the amount of air and fuel that can be drawn into the engine while the engine is operating. Cooler air is more oxygenated than warmer air making cooler air more desirable for internal combustion engines. A restriction in the flow rate of either the fuel or the intake air can also directly result in the loss of available horsepower from the engine. Therefore, there is a recognized need to provide proper filtration of the air drawn into an engine while still allowing the maximum volume of cooler to pass into the engine cylinders for combustion.

Many devices have been designed to provide filtration of engine air. Most of these devices consist of simple housings which contain a single filtration element. In the case of naturally aspirated gasoline engines equipped with carburetors, the housing is normally configured to rest upon the top of the intake portion of the carburetor. The situation is different for fuel injected engines. The general configuration of fuel injected engines includes an intake manifold that ports the air fuel mixture to the individual engine cylinders. Each cylinder usually has its own dedicated fuel injector that introduces fuel to the engine cylinder and the fuel injector is normally located on or near the air intake manifold. Prior to passing into the intake manifold and the engine cylinders, there is a throttle body that contains at least one butterfly valve that controls the amount of air that passes into the air intake manifold and into the engine cylinders. Ahead of the throttle body is an air intake system that usually contains an air metering devices that works to coordinate the fuel and air mixture being provided to the engine cylinders. The air intake system usually terminates in an air filtration device mounted to the end of an air intake tube. It is this air intake device that forms the technical field of the present invention.

2. Description of Related Art

Within the field of engine filtration devices, there are a number of inventions that have been designed to provide air filtration for engines. While these devices provide filtration to engines, each of them may result in the introduction of warm air into the engine and usually introduce substantial restrictions of the air being drawn in to the engine.

U.S. Pat. No. 6,258,144 issued to Huang is an air filtration device that includes two cone-shaped filtering members that are coaxially mounted within a housing, and also includes a ring with blades that generates a spiral flow of air to the engine. The primary purpose of the invention is to change the flow of the air into the air intake system from a turbulent state to a more controlled spiraling state as the air passes through the air intake tubing. In accomplishing this goal, however, the volume of air is strictly dependent upon the air porosity of the filtration element. When the air filtration element is covered with a layer of restrictive debris, the ability of the element to allow passage of air into the engine is severely compromised.

In U.S. Pat. No. 5,858,044 issued to Nespund et al., provides an alternative filtering device. That invention includes a combination of two types of filtering elements. The first element acts as a pre-filter to prevent the entry of large contaminants into the engine. The second filtering element is made from foam and is intended to prevent the entry of smaller contaminants into the engine. Although the filter may provide good filtration of the intake air, the result of this double filtering can be the collection of two layers of debris through which the intake air must pass before being able to enter the engine.

A number of other similar air filtering devices with similar drawbacks are disclosed in other patents such as U.S. Pat. No. 6,261,333 issued to Dickson, U.S. Pat. No. 4,235,611 issued to Brownell, U.S. Pat. No. 4,197,101 issued to Cote, et al, U.S. Pat. No. 5,562,746 issued to Raether, and U.S. Pat. No. 5,368,621 issued to Pool. While each of these devices provides an air filtration system for an engine, each of them does so with the disadvantage of creating a barrier that can severely reduce the flow of intake air to an engine, and none of these devices provides an air filtering device that can be spliced into the tubing of an air intake system and that will provide a good flow of cooler air at various engine rotation rates.

### SUMMARY OF THE INVENTION

This patent application relates to air filters in general, and specifically, to a multi port air filter that will allow the entry of cooler air into the air intake system of a fuel injected engine. The present invention contains a unique combination of filters and screens that acts to improve the performance of the air filtering system of the engine by controlling the incoming air at various engine RPM's. The flexible reticulated polyurethane foam used within the multi port filter captures contaminants without a rapid build up of a debris layer that reduces air flow to the engine. The foam material also reduces the need to constantly clean or replace the filter element.

Other objects and features of the present invention will be in part apparent and in part pointed out hereinafter.

### DESCRIPTION OF THE DRAWINGS

FIG. 1 is a front view of one embodiment of the present invention.

FIG. 2 is an exploded view of one embodiment of the present invention showing the arrangement of the various components of the invention.

Corresponding reference characters indicate corresponding parts throughout the several views of the drawings.

### DETAILED DESCRIPTION OF THE INVENTION

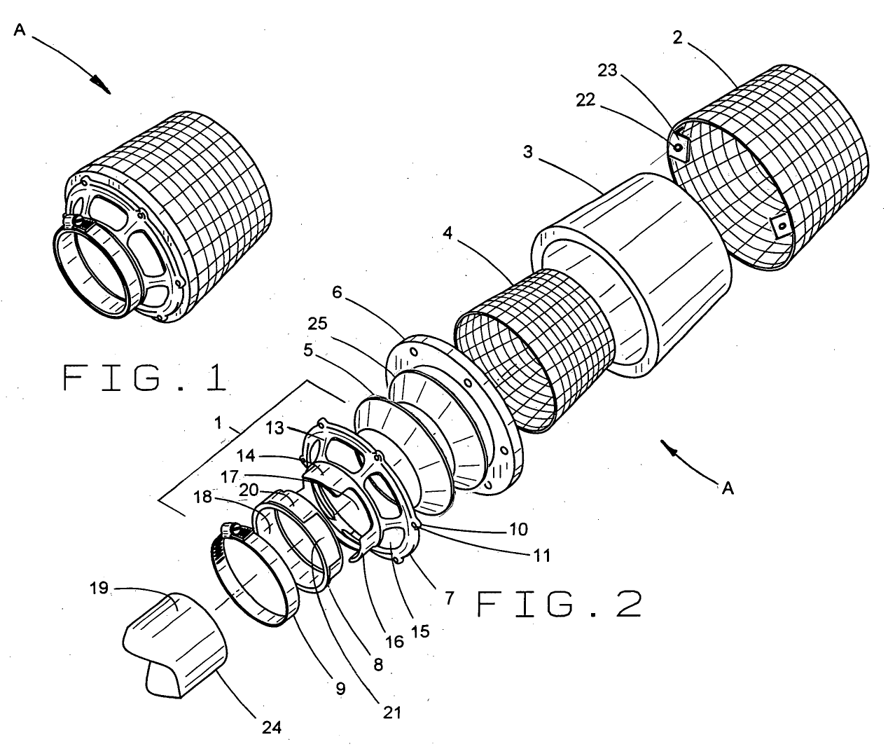

FIG. 1 shows one embodiment of the present invention of a multi port air filter A. FIG. 2 shows an exploded view of the multi port air filter A and displays the arrangement of the components of the multi port air filter A. The multi port air filter A includes a housing 1 which contains an outside filter screen 2, a foam filter 3, an inside filter screen 4, a mesh filter 5, and a filter support plate 6. The outside filter screen 2 and the inside filter screen 4 contain a plurality of openings that enhance the operation of the filter.

The housing 1 includes a main housing 7, a housing grommet 8, and a clamp 9. The main housing 7 has a plurality of protrusions 10 with each protrusion having a fastener opening 11. The main housing 7 includes a generally cone-shaped portion 13 and a generally cylindrical portion 14. The filter support plate 6 is generally washer shaped and has a plurality of openings 12 and these openings are sized and located to match the fastener openings 11 of the main housing 7. Installation of three fasteners into the matching openings 11 and 12 attach the filter support plate 6 to the main housing 7.

While the main housing 7 and the filter support plate 6 of the present embodiment are made from metallic material, other materials may be used so long as they are able to function within the environment of an automobile engine bay.

It will be noted that in the present embodiment the outer filter screen 2, the foam filter 3, and the inside filter screen 4 are in a matching generally frustoconical shape. It will be appreciated that other shapes may also be used while still remaining with the scope of the present invention. For example the overall shape may be in the general form of a sphere, a cylinder, a cone, or a mushroom. Additionally, while the shape of the plurality of openings within the material that make up the outside filter screen 2 and the inside filter screen 4 of the present embodiment are square shaped, other shapes such as diamonds, hexagons, and circles may also be used while still remaining within the scope of the present invention.

In the present embodiment, the generally cone-shaped portion 13 has a plurality of generally elliptical air flow openings 15 located in a radial pattern around the cone shaped portion 13. IN an alternate embodiment of the present invention, there is at least one such air flow opening 15. The generally cylindrical portion 14 comprises a plurality of alternating curved flanges 16 and curved openings 17.

The housing grommet 8 is generally ring shaped and is configured to fit within the opening of the generally cylindrical shaped portion 14 of the main housing 7. The housing grommet 8 has an inside circumferential surface 18 that is sized to fit the outside diameter 19 of the air intake tubing 24 that exists on the air intake system of a gasoline engine (not shown). It is understood that the actual size of the inside diameter of the inside circumferential surface 18 will be determined by the size of the air intake tubing 24 of the particular air intake system upon which the multi port air filter A will be mounted. This diameter, however, should be such that when the multi port filter A is installed, the entrance of air between the inside circumferential surface 18 and the outside surface 19 of the air intake tubing 24 is minimized.

The housing grommet 8 has a plurality of indented surfaces 20 on its outer circumferential surface 21. The plurality of indented surfaces 20 are located and shaped to match the location and shape of the plurality of alternating curved flanges 16 and curved openings 17 in the main housing 7. The radial depth of the plurality of indented surfaces 20 in the housing grommet 8 is such that the main housing grommet 7 can be installed over the housing grommet 8 such that there is a slight interference fit between the inside diameter of the curved flanges 16 of the main housing 7 and the plurality of indented surfaces 20. The slight interference fit results in a tight fit between the inside circumferential surface 18 and the outside surface 19 of the air intake tubing 24 after the housing grommet 8 and the main housing 7 have been installed over the air intake tubing 24, and the clamp 9 has been positioned and tightened over the housing grommet 8.

The outside filter screen 2 is a generally frustoconically shaped cup with an opening in the bottom sized to accept the foam filter 3 with little or no clearance. The outside filter screen 2 of the present embodiment is constructed of a square mesh metallic material that has been deep drawn to generate an inside configuration matching the outside shape and configuration of the foam filter 3. It will be appreciated by those skilled in the art that other types of materials having other shaped openings may also be used to fabricate the outside filter screen. For example, the outside filter screen 2 may be steel, aluminum, plastic, ceramic, composite carbon, rigid cloth, or any other similar material provided the material selected is capable of being formed into the shape described herein, has openings adequate to allow for appropriate air flow through the material, and will not be damaged by the heat, moisture, vibration, and other detrimental characteristics of the environment found within the engine bay of automobiles. The outside filter screen 2 has three clip angles 23. Each of the clip angles 23 has a threaded opening 22 that allows the outside filter screen 2 to be attached to the filter support plate 6 with three fasteners (not shown). Because the foam filter 3 and the inside filter screen 4 are inserted inside the outside filter screen 2, the attachment of the outside filter screen 2 to the filter support plate 6 captivates the foam filter 3 and the inside filter screen 4 within the multi port filter A.

In the embodiment described herein, the foam filter 3 is made from flexible reticulated polyurethane foam material. This washable material has a unique three dimensional cellular structure that captures debris without a rapid loss in air flow through the foam filter. This foam material is operable within the temperature range of from about +225 degrees Fahrenheit to about −40 degrees Fahrenheit. While flexible reticulated polyurethane foam is used in the present embodiment, it will be appreciated that other types of materials may be used in other embodiments so long as adequate air flow through the foam filter 3 is maintained. The foam filter 3 is a generally frustoconically shaped cup sized such that the closed end of the cup will fit within the outside filter screen 2 and the open end of the cup will fit around the outside surface of the inside filter screen 4.

The inside filter screen 4 is also in the form of a generally frustoconically shaped cup and is sized to fit inside the foam filter 3. The inside filter screen 4 is manufactured from the same materials from which the outside filter screen 2 is manufactured. The sizes and shapes of the outer filter screen 2, the foam filter 3, and the inside filter screen 4 are such that, when these components are assembled, the foam filter 3 and the inside filter screen 4 are encapsulated within the outer filter screen 2 and are held in place by the friction existing between the contacting surfaces of all three components.

The mesh filter 5 is made from a metallic screen material made from wire of about 0.015 inches thick. The mesh filter 4 is sized and shaped to match the generally cone shaped portion 13 of the housing 7.

In its assembled form, the multi port air filter A includes the outside filter screen 2, the foam filter 3, the inside filter screen 4, the filter support plate 6, the mesh filter 5 and the main housing 7 assembled as a single unit. While the housing grommet 8 and the clamp 9 may also be installed onto the main housing 7 for storage or shipment, the housing grommet 8 and the clamp 9 must be removed from the main housing 7 for installation of the multi port air filter A.

Installation of the multi port filter A is accomplished by attaching it to the intake tube 24 of an engine's air induction system. First, the clamp 9 and the housing grommet 8 are slipped over the outside of the air intake tube 24. The main housing 7 is slipped over the grommet housing 8 and the clamp 9 is opposition over main housing 7 such that the clamp 9 squeezes the housing grommet 8 and the main housing 7 against the outside surface of the air intake tube 24. The clamp 9 is then tightened to secure the multi port air filter A to the air intake tube 24.

When fully assembled and installed the present embodiment of the inline air filter A has a flow rate of at least about 227 cubic feet per minute and is capable of filtering out debris having a size of at least about 25 microns or larger.

The unique combination of filters and screens as described above has been shown to improve the performance of the air filter system by efficiently controlling and introducing cooler incoming air at different RPM ranges thus optimizing engine performance.

While the above description describes various embodiments of the present invention, it will be clear that the present invention may be otherwise easily adapted to fit any configuration where a multi port air filter A may be utilized.

In view of the above, it will be seen that the several objects of the invention are achieved and other advantageous results attained. As various changes could be made in the above constructions without departing from the scope of the invention, it is intended that all matter contained in the above description or shown in the accompanying drawings shall be interpreted as illustrative and not in a limiting sense.

What I claim is:

1. A multi port air filter for use in conjunction with an air intake system of an internal combustion engine comprising:
an outside filter screen;
a foam filter;
an inside filter screen;
a mesh filter;
a filter support plate; and
a housing comprising,
a main housing;
a housing grommet; and
a clamp.

2. The multi port air filter of claim 1 wherein the main housing has a plurality of protrusions with each protrusion having a fastener opening and wherein the main housing includes a generally cone-shaped portion and a generally cylindrical portion.

3. The multi port air filter of claim 2 wherein the housing has at least one opening located in the cone shaped portion.

4. The multi port air filter of claim 3 wherein the generally cylindrical portion comprises a plurality of alternating curved flanges and curved openings.

5. The multi port air filter of claim 4 wherein the filter support plate is generally washer shaped and has a plurality of openings, the openings being sized and located to match the fastener openings of the main housing.

6. The multi port air filter of claim 5 wherein the housing grommet is generally ring shaped and is configured to fit within the opening of the generally cylindrical shaped portion of the main housing.

7. The multi port air filter of claim 6 wherein the housing grommet has an inside circumferential surface having an inside diameter sized to fit an outside surface of an air intake tubing of a gasoline engine, the inside diameter, being sized such that when the multi port filter is installed, entrance of air between the inside circumferential surface and the outside diameter of the air intake tubing is minimized.

8. The multi port air filter of claim 7 wherein the housing grommet has a plurality of indented surfaces on its outer circumferential surface.

9. The multi port air filter of claim 8 wherein the plurality of indented surfaces are located and shaped to match the location and shape of the plurality of alternating curved flanges and curved openings in the main housing.

10. The multi port air filter of claim 9 wherein the radial depth of the plurality of indented surfaces in the housing grommet is such that the main housing can be installed over the housing grommet such that there is a slight interference fit between the inner surfaces of the curved flanges of the main housing and the plurality of indented surfaces, the slight interference fit resulting in a snug fit between the inside circumferential surface and the outside surface of the air intake tubing after the housing grommet and the main housing have been installed over the air intake tubing and the clamp has been positioned and tightened over the housing grommet.

11. The multi port air filter of claim 10 wherein the outside filter screen is shaped to match the outside shape and configuration of the foam filter, the outside filter having a plurality of air openings.

12. The multi port air filter of claim 11 wherein the outside filter screen is manufactured from a material chosen from the group consisting of steel, aluminum, plastic, ceramic, composite carbon, or rigid cloth.

13. The multi port air filter of claim 12 wherein the sizes and shapes of the outside filter screen, the foam filter, and the inside filter screen are such that, when these components are assembled, the foam filter and the inside filter screen are encapsulated within the outside filter screen and are held in place by the friction existing between the contacting surfaces of the outer filter screen, the foam filter, and the inside filter screen 4.

14. The multi port air filter of claims 13 wherein the inside filter screen 4 is manufactured from a material chosen from the group consisting of steel, aluminum, plastic, ceramic, composite carbon, or rigid cloth.

15. The multi port air filter of claim 14 wherein the general shape of the outer filter screen, the foam filter, and the inside filter screen is in the general form of a shape selected from the group consisting of a sphere, a cylinder, a cone, a frustocone, or a mushroom.

16. The multi port air filter of claim 15 wherein the foam filter is made from a flexible reticulated polyurethane foam material.

17. The multi port air filter of claim 16 wherein the plurality of air openings within the material used to make the outside filter screen and the inside filter screen are one of either a square shape, a diamond shape, a hexagon shape, or a circular shape.

18. The multi port air filter of claim 17 wherein the inside filter screen is in the form of a generally frustoconically shaped cup and is sized to fit inside the foam filter.

19. The multi port air filter of claim 18 wherein the outside filter screen is a generally frustoconically shaped cup with an opening in the bottom sized to accept the foam filter with little or no clearance.

20. The multi port air filter of claim 19 wherein the foam filter is a generally frustoconically shaped cup sized such that the closed end of the cup will fit within the outside filter screen and the open end of the cup will fit around the outside surface of the inside filter screen.

21. The multi port air filter of claim 20 wherein the foam material is washable, has a three dimensional cellular structure and is operable within the temperature range of from about +225 degrees Fahrenheit to about −40 degrees Fahrenheit.

22. The multi port air filter of claim 21 wherein the mesh filter is made from a metallic screen material having a wire about 0.015 inches thick.

23. The multi port air filter of claim 22 wherein the multi port air filter has an air flow rate of at least 227 cubic feet per minute.

24. The multi port air filter of claim 23 wherein the multi port air filter filters out debris having a size of at least 25 microns.

25. A process of using a multi port air filter for filtering air in conjunction with an air intake system of an internal combustion engine comprising the steps of:
providing an outside filter screen;
providing a foam filter;
providing an inside filter screen;
providing a mesh filter;
providing a filter support plate;
providing a housing, the housing comprising a main housing, a housing grommet; and a clamp;
assembling the outside filter screen, the foam filter, the inside filter screen, the mesh filter, and the filter support plate onto the housing; and
installing the above components onto a component of an air intake system of a fuel injected engine.

26. The process of claim 25 wherein the assembled multi port air filter has an air flow rate of at least 227 cubic feet per minute and is capable of filtering debris having a size of at least 25 microns.
